(19) United States
(12) Patent Application Publication
(10) Pub. No.: US 2008/0086310 A1
(43) Pub. Date: Apr. 10, 2008

(54) Automated Contextually Specific Audio File Generator

(76) Inventor: Kent Campbell, Santa Paula, CA (US)

Correspondence Address: MUSKIN & CUSICK LLC, 30 Vine Street, SUITE 6, Lansdale, PA, 19446, US

(21) Appl. No.: 11/539,737

(22) Filed: Oct. 9, 2006

(51) Int. Cl. G10L 11/00

(52) U.S. Cl. 704/278

(57) ABSTRACT

A system to generate a contextually specific custom audio file targeted to the user. The user can be a traveler who has particular travel data and the system can generate content tailored to the user's travel data. The content in the audio file can be chosen based on relevancy to the user's travel data. The audio file can be served to the user via a computer communications network such as the Internet.

### BACKGROUND OF THE INVENTION

1. Field of the Invention

The present inventive concept relates to a contextually specific custom audio file generator that can be used, as one example, as information that can be helpful to a traveler.

2. Description of the Related Art

People commonly use the Internet to make travel arrangements. Travelers can also purchase audio tapes which provide information about particular destinations. However, the audio tapes are generic, they are not created for the specific travel needs or itineraries of individual people.

What is needed is a way to generate audio files which are targeted to individuals. This can result in more relevant audio files in which individuals may prefer over the generic audio currently available.

### SUMMARY OF THE INVENTION

It is an aspect of the present invention to provide an automatic targeted audio file generator.

The above aspects can be obtained by an apparatus that includes (a) receiving user data which comprises travel data, relating to a user and/or the user's trip; (b) retrieving particular audio files relating to the user data; (c) combining the particular audio files to create a customized audio file; and (d) serving the customized audio file to the user.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating an exemplary method of generating a targeted audio file, according to an embodiment;

FIG. 2 is a flow diagram illustrating examples of how audio files can be generated, according to an embodiment;

FIG. 3 is a flowchart illustrating an exemplary method of automatically generating a targeted audio file using data from an online travel agent, according to an embodiment;

FIG. 4 is a flowchart illustrating an exemplary method of generating an audio file using templates and variable content, according to an embodiment;

FIG. 5 is a block diagram illustrating different components of the system, according to an embodiment;

FIG. 6 is a flowchart illustrating an exemplary method to determine variable content to be used in the audio file, according to an embodiment; and

FIG. 7 is one example of a customized audio file, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present general inventive concept relates to a system which can generate targeted audio files for a traveler. Please note that the systems and methods described herein can also be used in other contexts besides travel.

In a first embodiment, a system can be implemented wherein a user can visit a web site and fill out a questionnaire over the Internet (e.g., using a web browser). The questionnaire can ask questions such as the user's native language, the country he or she is going to visit, the travel dates, where the user is staying, etc. Based on these responses, the system can then generate a contextually specific custom audio file based on the user's answers.

User data can comprise any data known about the user, which may include (but not limited to) his or her age, sex, native language, residence, income, etc. User data can also include travel data, which can comprise data relating to the user's upcoming trip, including (but not limited to) the destination, dates traveled, hotel stayed at, airline used, etc.

For example, if the user fills out the questionnaire as follows: his native language is English; his name is Bill; he is visiting Cancun, Mexico on September 10-15, and is staying at Casa Loca. The system would store (in a database such as an SQL based database) audio files associated with each of the potential answers to the survey. Audio files can also be associated with multiple answers of the survey. An example audio file generated for this example can be as follows, “Hello Bill. You will greatly enjoy your stay in Mexico. Cancun is a very lively city. On September 12 in Cancun there will be a Tilapia Festival on Main Street. A recommended restaurant near your hotel is called Carmen's Comida, on Cerveza Street. We hope you enjoy your trip!”

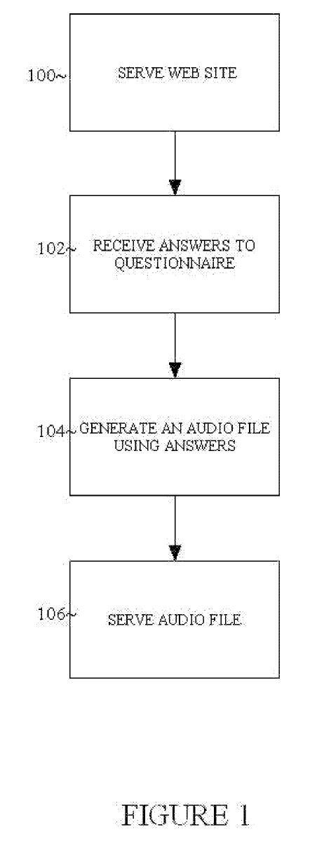

FIG. 1 is a flowchart illustrating an exemplary method of generating a contextually specific custom audio file, according to an embodiment.

The method can being with operation 100, which serves a web site (or pages of the web site) to a user. This can be done using a server as known in the art. The web site can contain a questionnaire.

The method can proceed to operation 102, which receives the user's answers to the questionnaire. The answer's can be submitted on a web page using standard checkboxes, radio buttons, or any other method known in the art to receive information over a web page. The user's answers are transmitted back to the server.

From operation 102, the method can proceed to operation 104, which generates an audio file from files in a database that correspond with the answers submitted in operation 102. More on how this operation is implemented will be presented herein in more detail.

From operation 104, the method can proceed to operation 106, which serves the audio file. This can be done as known in the art, such as via email, ftp, streaming audio, mailing a computer readable storage medium (e.g. a CD-ROM) to the user, etc.

Thus, a user can take a survey electronically and receive a contextually specific custom audio file targeted to the user. The contextually specific custom audio file will typically be more enjoyable to the user since it contains information that relates to the users individual experience.

This audio file can be generated in many ways. For example, a database of templates can be stored. For example, a different template can be stored for each native language. The template typically contains pointers (or any kind of identifier) of all of the audio files (typically stored in MP3 or other audio format) that the audio file will definitely contain, their presentation order, and also can point to subtemplates which can vary based on certain parameters (e.g., particulars the system knows about Bill's trip).

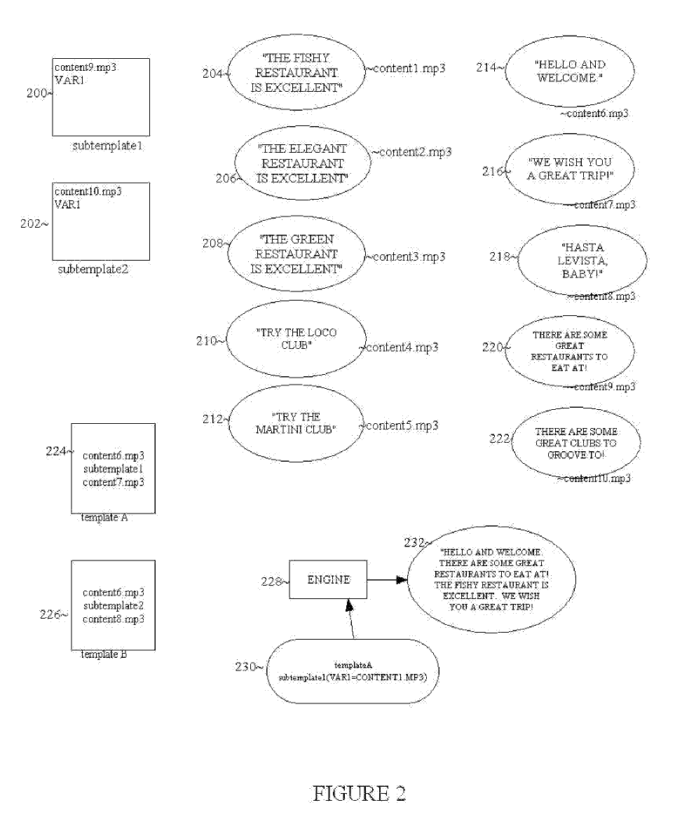

FIG. 2 is a flow diagram illustrating examples of how audio files can be generated, according to an embodiment.

Subtemplate1 200, subtemplate2 202, template A 224, and template B 226, can be stored in a template database. Content1.mp3 204, content2.mp3 206, content3.mp3 208, content4.mp3 210, content5.mp3 212, content6.mp3 214, content7.mp3 216, content8.mp3 218, content9.mp3 220, and content10.mp3 222, are all audio files and can be stored in a content database. The template database and the content database can be the same database or separate databases.

In this particular example, template A is intended for an older (e.g. over 30) visitor to Toronto who speaks English, and template B is intended for a younger visitor (e.g. under 30) to Toronto who speaks English. The older visitor may be more likely to be interested in visiting a restaurant, while the younger visitor may be more likely to be interested in going to clubs. Thus, the customized audio file can be tailored to such characteristics.

Table I below is an exemplary data structure which can be used by the system to select the appropriate template. A lengthier table can be used to determine the appropriate template for tens, hundreds, or thousands, of templates based on different characteristics of users.

TABLE I

| Language | destination | age | template |
|---|---|---|---|
| English | Toronto | older | template A |
| English | Toronto | younger | template B |
| Russian | France | older/younger | template C |

Note that template A 224 includes content6.mp3 (which is an audio file for “HELLO AND WELCOME”) and then includes subtemplate1 (more on this below) and then includes content7.mp3 (which is an audio file for “WE WISH YOU A GREAT TRIP!”) Note that template B 226 includes content6.mp3 (which is an audio file for “HELLO AND WELCOME”) and then includes subtemplate2 (more on this below) and then includes content8.mp3 (which is an audio file for “HASTA LAVISTA, BABY”). It can be predicted that the younger traveler may prefer the latter message over the (“WE WISH YOU A GREAT TRIP!”) that template A 224 (for the older traveler) will receive.

Subtemplates work similarly to templates, that is, they contain tags that may be associated with certain audio files. Like templates, subtemplates can also contain variables which can play a particular audio file depending on a variable (a parameter based on the particular travelers characteristics).

Subtemplate1 200 would produce an audio file that contains, “THERE ARE SOME GREAT RESTAURANTS TO EAT AT!” and then would include a content filename passed as a variable (VAR1). Subtemplate2 202 would produce an audio file that contains, “THERE ARE SOME GREAT CLUBS TO GROOVE TO!” and then would include a content filename passed as a variable (VAR1).

Thus, consider a traveler who is 50, speaks English, and is visiting Toronto. His respective template, using a table such as Table I, is determined to be template A. Templates can also require variables to be passed to them based on more customized content. For example, there may be 100 restaurants in Toronto to recommend to the traveler, but this 100 can be narrowed down to 3 restaurants for inclusion in the audio file. The three (or any amount) selected restaurants can be chosen based on a number of criteria, for example: best rated, closest to traveler's hotel, cuisine compatible with traveler's preferences, bid placed by restaurants for inclusion in the audio file, or any other criteria. Any one or combination of these criteria can be used, and different weights can even be used.

A table (or any other data structure) can be used to determine which variables may be needed for each template. Table II below is an exemplary data structure which can be used by the system to determine which parameters are needed for each template. In our example, since templateA has been selected for the traveler in our example, Table II indicates that one variable is needed, Var1, which is a restaurant in Toronto. A database (for example an SQL based database) can maintain a list or restaurants in Toronto and/or their respective mp3 filenames (e.g. “YOU MAY LIKE THE JONES RESTAURANT.”) The table may also list the selection criteria for the variable, in this case the selection criteria is the highest bidder (this aspect will be presented below in more detail).

TABLE II

| Template | variables | represents | selection criteria |
|---|---|---|---|
| TemplateA | Var1 | restaurant in Toronto | highest bidder |
| TemplateB | Var1 | restaurant in Toronto | highest bidder |

Thus, the database can be queried for a restaurant in Toronto with the highest bidder, and assume the result is the fishy restaurant with associated content filename content1.mp3. Thus, template A can be called with Var1=content3.mp3.

Thus, in operation 230, the engine receives a request to use template A with var1 (for subtemplate1) equal to content1.mp3 (this is one example of variable content). The engine 228 then retrieves template A from the template database, and after reading template A, retrieves content file content6.mp3, then retrieves subtemplate1 from the template database, which then indicates content9.mp3 is included and thus content9.mp3 is retrieved from the content database, then since var1 is equal to content1.mp3, content1.mp3 is retrieved from the content database, and then going back to template A, content7.mp3 is retrieved from the content database. All of these content files are appended in sequence, and the result is an audio file (can be mp3, wav, or any audio format), that says, “HELLO AND WELCOME. THERE ARE SOME GREAT RESTAURANTS TO EAT AT! THE FISHY RESTAURANT IS EXCELLENT. WE WISH YOU A GREAT TRIP!”

Thus, it is noted that the audio file generated is tailored to the particular traveler in question and presents subtle advertisements for targeted goods and/or services that the traveler may be more likely to take advantage of as opposed to generic goods and/or services that are presented to all travelers.

In addition to filling out a questionnaire (as illustrated in FIG. 1), the customized audio file can be generated by using data already obtained by an online travel agent. An online travel agent is a web site or other Internet based tool which can book airline and hotel reservations for a user online. Since the online travel agent already knows information such as the user's native language, his travel dates, his destination, etc., this data can be passed to an audio file generating system (as described herein) so that a customized audio file can be generated automatically.

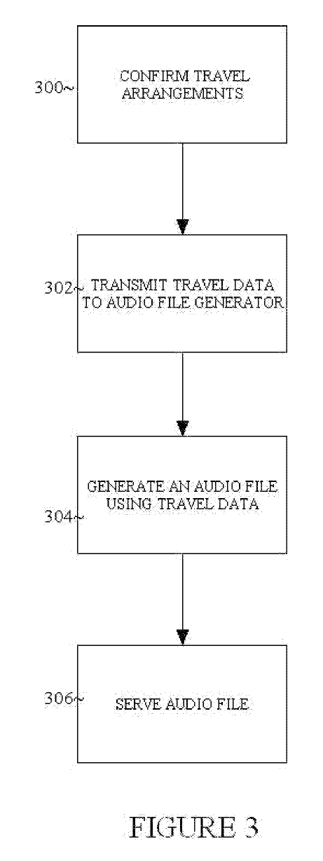

FIG. 3 is a flowchart illustrating an exemplary method of automatically generating a targeted audio file using data from an online travel agent, according to an embodiment.

The method can begin with operation 300, wherein an online travel agent confirms travel arrangements. The user books his or her travel arrangements, upon completion of which the online travel agent sends the user a confirmation of the user's travel plans.

From operation 300, the method can proceed to operation 302, which transmits the user's travel data to an audio file generator. The online travel agent may ask the user's permission before transmitting his or her data, or it may just do so automatically without asking permission. The audio file generator may also be owned by the same party as the online travel agent, thus no permission may be needed.

From operation 302, the method can proceed to operation 304, which generates an audio file using the travel data transmitted in operation 302. The audio file can be generated as described herein.

From operation 304, the method can proceed to operation 306, which serves the audio file to the user. This can be done as known in the art, e.g., via email, FTP, direct download, etc.

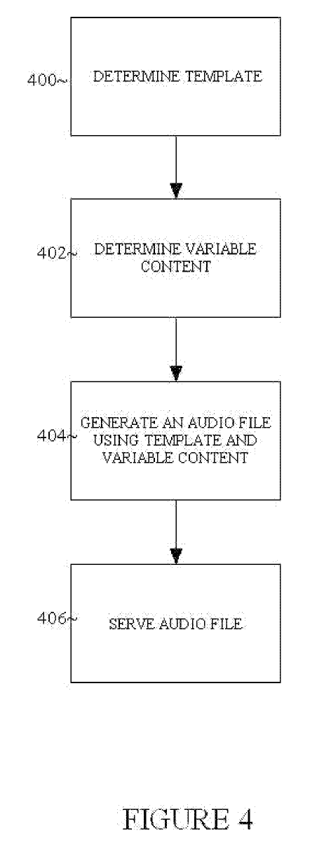

FIG. 4 is a flowchart illustrating an exemplary method of generating an audio file using templates and variable content, according to an embodiment.

The method can start with operation 400, which determines which template to use. This depends on the individual the audio file is being customized for and can be determined as described herein. Different user data can be mapped to different templates, so users with particular data (e.g. destination, level of spending, age, sex, travel dates, etc.) will have generated an audio file with a relevant template which will have relevant information for that user.

From operation 400, the method can proceed to operation 402, which determines variable content. Variable content can be content chosen specifically for the individual depending on his or her travel data. For example, if the user is traveling to a certain destination on a certain date, an audio segment may be used (variable content) which describes an event occurring on that time. Variable content can also be determined by determining who a winning (or highest) bidder is of a particular subset of points of interested (e.g., the highest bidder of all fancy restaurants in Toronto).

From operation 402, the method can proceed to operation 404, which generates an audio file using the template determined from operation 400 and the variable content determined in operation 404. This can be accomplished as described herein.

From operation 404, the method can proceed to operation 406, which serves the audio file to the individual. This can be accomplished as described herein and as known in the art.

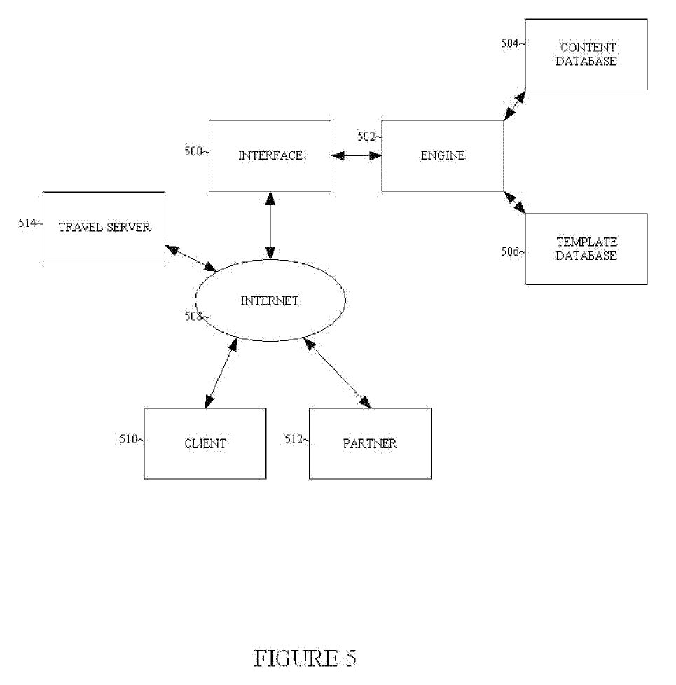

FIG. 5 is a block diagram illustrating different components of the system, according to an embodiment.

A client 510 (traveler, end-user, etc.) is connected to a computer communications network such as the Internet 508 using a web browser, as known in the art. A travel server 514 (also known as online travel agent) can communicate with the client 510 via the Internet, wherein the user can book his or her travel.

A System Interface 500 can receive via the Internet 508 travel data relating to the client's 510 travel from the travel server 514. The travel data can comprise any data relating to the client's trip, as discussed herein, such as the destination, travel dates, client's age, nationality, etc. The System Interface 500 can transfer the travel data to the engine 502, which can generate a customized audio file using the content database 504 and the template database 506 as described herein. The engine 502 would then transfer the generated customized audio file to the System Interface 500 which can then serve the customized audio file back to the client 510 via the Internet 508. The engine 502 can also be directly connected to the Internet 508 as well. The engine can reside on a server which has software to implement the operations described herein which relate to the customized audio file.

A partner 512 can communicate with the travel server 514, the System Interface 500, and the engine 502 in order to have the partner's marketing messages included in the audio file. While not pictured, a plurality of partners can communicate with the travel server 514, the System Interface 500, and the engine 502 and any other components. More on the partners will be discussed below in greater detail.

A fulfillment system can be connected to (or part of) the system interface 500 and can be considered a staging area where the customized audio file is sent for retrieval by the respective traveler. The fulfillment system, in addition to storing the file, can also alert the correct server that the file is ready for downloading.

Content can be created by native language speakers according to frequently updated scripts. New sponsors can be added according to a pre-defined schedule according to variables such as market share, or when the sponsors sign up. Event information (e.g. when events occur in certain locations, e.g. fairs, etc.) can be updated periodically (e.g. once a quarter).

Pre-defined sponsor content allows a prospective sponsor to logon to the system and sample an audio file that actually contains their brand message. For example, a representative of the Kola Corporation can logon to the interface 500 or engine 502 and hear a sample of an audio file with their brand embedded in it (e.g., “While in your hotel, try a can of Kola, the local brand of soda.”)

A content management system (CMS) can comprise the system interface 500, the engine 502, and the databases (content database 504, template database 506, and any other databases), and any other components (including their software) which operate together in order to receive the relevant information relating to a trip, as well as information relating to the traveler, and putting together a customized audio file. The content management system can operate as a workflow manager managing a single audio or text file from creation through editing, quality control, upload, template placement, engine, fulfillment, and ultimately end-user download tracking.

Field technicians can upload audio and text files using the system interface 500 (e.g. using a GUI interface which allows the technicians access to the proper directories and areas on the server(s)), manipulate templates, and any other operations needed in order to maintain proper operation and maintenance of the system. A human operator, such as a content manager, can check the files uploaded by field technicians, edit them as necessary, and then place the files in the appropriate places within the respective databases for retrieval by the engine. A database of time based events can also be maintained (e.g., an event, location, and time), so that respective time based events can be retrieved which may coincide with the travelers destination and/or time. For example, if there is a wine tasting content in Paris, on Jan. 3, 2008, this information is stored in a database so appropriate events can be retrieved which coincide with the traveler's own travel dates/location.

The template database 506 stores the templates. The templates can be though of as an itemized ordering of information. A template creates a logical matrix for the placement of files that will eventually be output by the engine as a linear audio or text file (or both). Templates may contain sub-templates. For example, a particular credit card (ChargeItCard) may contain a sub-template for each of Gold (high spending, e.g., charges over a predetermined threshold (e.g., $100 k), silver (average spending), or black (low spending level, under a predetermined threshold (e.g. $2 k)). The ChargeItCard company can maintain their own database to identify and categorize each of their customers based on their spending level (this information can be transferred to the engine or any other components described herein for use in generating a customized audio file). For example, the gold sub-template may have a placeholder within the sub-template for a list of nearby private airfields or other exclusive information.

For example, a template can exist for all ChargeItCard customers, and a subtemplate can exist for each level of spending (gold, silver, or black). A sub template can also exist for gold users with a mobile device XML protocol. Thus, users with high or low spending may get different content, and users with different devices can also get different content (e.g. abridged content for mobile devices).

Templates can be very flexible and can create audio files and/or text files. They can have various types of information “slots” available, such as geographic, accommodation, transportation, time, weather, local information, language translation, and more.

When a request for a customized file is transmitted, it can generate a simple customized audio file or a complex one. For example, a complex file might be: American English to Parisian French; arriving Paris Charles du Gaul airport, Dec. 12, 2006, Lufthansa flight 12; hotel—Louvre St. honore; Car: Hartz Paris location; ChargeItCard gold level, spending code X; language fluency 2; interests include golf, wine tasting, tennis, use would like information delivers via MP3 to be downloaded from web browser and the abbreviated version sent to mobile telephone number 212-555-1212.

Templates can contain three general types of slots: Core, sponsored, and basic. Core information is supplied by the user directly or by a partner (such as ChargeItCard), e.g., “you can use your ChargeitCard at thousands of locations throughout your travels in Spain.” Sponsored is information subtly inserted into language dialogue and in other areas throughout the template such as “Kola” instead of “water.” Basic is information inserted throughout the template—the word “water” instead of the sponsored word “Kola” or non-sponsored attractions like the Eiffel Tower.

An aspect of the present inventive concept allows more than one partner to competitively bid against each other in order to achieve placement of their advertisements in particular audio files which are served to users. For example, Toronto restaurants may prefer to have themselves included in audio files generated for a traveler who is visiting Toronto.

Referring back to table II, a restaurant in template A is to be chosen for inclusion. This restaurant must be a restaurant in Toronto. A database can store many restaurants in many different cities. The database may retrieve 100+ restaurants in Toronto. The system can then narrow certain restaurants by other criteria, since an audio file may only call for one (or three or any limited number) of content files pushing particular restaurants.

Restaurants can optionally participate in bidding for inclusion in audio files. For example, any of the Toronto restaurants known to the database may place bids (not unlike how major search engines take bids for ads), and the highest bidders can be selected for including in the customized audio file. Thus for example, restaurant A may bid $1, restaurant B may bid $1.10, and restaurant C may bid 0.90, and if all these restaurants meet the criteria for including in an audio file (e.g., are in Toronto), and if there are two slots for restaurants, then the highest two bidders (restaurant A and restaurant B) can be included in the customized audio file, and each respective restaurant will be charged their respective bid amount.

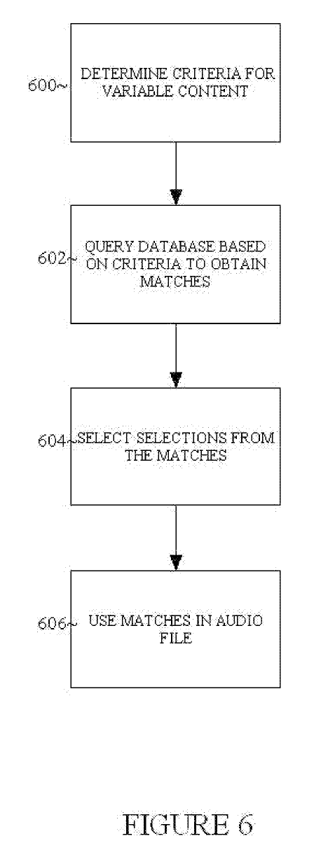

FIG. 6 is a flowchart illustrating an exemplary method to determine variable content to be used in the audio file, according to an embodiment.

The method can start with operation 600, which determines criteria for variable content. This can be done by associating templates with variable content, such as in Table II (see “represents” column).

Once the criteria for the variable content is known, a database which contains points of interest (hotels, restaurants, parks, monuments, etc.) can be queried. Each point of interest should typically have a corresponding audio file which may or may not contain a subtle advertisement for that point of interest which could be included in the customized audio file. The database can be any type of known database, such as an SQL based database. When the database is queried, the database can return matches. Note that there may be more matches than is needed for the customized audio file

From operation 602, the method can proceed to operation 604, which selects selections from the matches. The number of selections selected is how many selections are needed for the customized audio file (e.g. the audio file may only recommend no restaurants or it may recommend many).

The selections are selected based on further criteria (see Table II, “selection criteria”). In this case, the list of restaurants can be further narrowed down to the highest bidder by a partner (restaurant that has decided to place bids in the system).

In this example, only one restaurant is needed, so the highest bidder of all of the restaurants that the database knows in Toronto is selected out of the matches. This selection also has associated with it an audio file (e.g. “Smith's restaurant is a well known dining establishment in the city”).

From operation 604, the method can proceed to operation 606, which uses the match (or matches) in the customized audio file. The match (or matches) determined in operation 604 can be passed to the engine which will then retrieve the corresponding audio file and place it in the customized audio file.

Note that other criteria can be used as well for operation 602. For example, a restaurant (or other point of interest) may have to be within a certain physical distance (e.g. within 20 miles) of the traveler's hotel.

Many other applications for templates/subtemplates can be implemented as well. For example, selected restaurants, products, services, events, or other points of interest (which can be selected using any selection method(s) described herein), can be embedded into foreign language instruction. For example, the following can be included in a generated audio file, “please take me to the Royal Hotel in French is ‘ . . . ’” In this case, the recipient's native language would be English, his trip would be to France, and the Royal Hotel was selected using the method(s) described herein (e.g., the Royal Hotel may have been the highest bidder out of all hotels in the destination city, or been one of the closest to the travelers destination, or been the actual hotel the user has booked.)

Examples of audio segments included in the custom audio files can include: language instruction that includes specific information relating to an individuals' travel itinerary such as the name of their hotel, the airline on which they are flying, their flight number or numbers, and/or itinerary specific travelers aid; Geographically specific restaurant recommendations based on the location of the users accommodations; Geographically specific restaurant recommendations based on the restaurant preferences of the user; Geographically and/or time relevant events such as festivals, concerts, or theater performances corresponding to the users travel itinerary; Tips and local information specific to geographic location of a users travel accommodations.

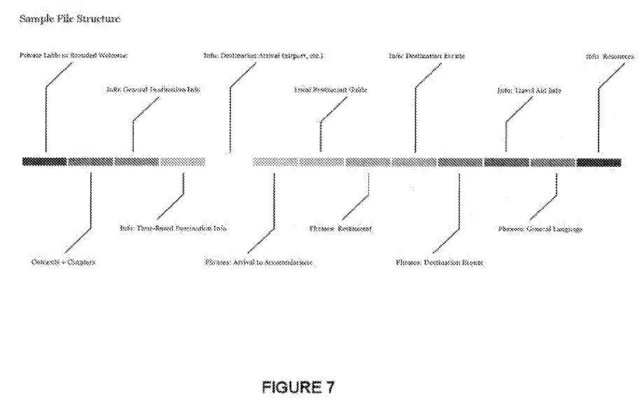

FIG. 7 is one example of a customized audio file, according to an embodiment.

The audio file is a sound file (using any format, such as MP3). The type of information and the order in which it is presented is based on the template used, which is chosen based on the information known about the traveler and/or the trip.

A file can begin, for example, with a branded welcome (e.g., “congratulations on your upcoming trip, feel free to use your ChargeItCard anywhere fine goods are sold”) wherein ChargeItCard is a sponsor of the system. The file can then include a table of contents/chapters (so the user may wish to fast forward to segments he/she prefers to listen to). The file can then include general destination information about the user's destination (e.g., “Spain is a fascinating country.”) The file can then include time based destination information (e.g., “while you will be in Spain there will be fantastic wine festival there . . . ”) The file can then include destination arrival information (e.g., “the Hartz car rental counter is located at your arrival airport near baggage claim B”) The file can include phrases, such as how to say “How do I get to the Royal Hotel” (the hotel the user is staying at or the Royal Hotel may be a winning bidder) in the language of the user's destination country, so that the user can learn a little of the local language. The file can also include audio about local restaurants (e.g. some that are close to the user's hotel and/or that may be winning bidders). For example, “Café da Man, greater breakfasts, with amazing powdered pastries in New Orleans.” The file may also contain lessons on how to say certain phrases (e.g., if the user is going to France, it may teach the user “‘Taxi, please take me to the blu’ restaurant is spoken in French by saying . . . ” The file can also contain information about destinations events (e.g., about a wine tasting contest) and how to say certain phrases in the local language relating to the destination events (e.g., “‘Let's go to the wine tasting contest’ is spoken in French by saying . . . ” The file can also contain information about travel aid (e.g., where banks are, embassy information, locations of sponsor offices, etc.), and phrase translations concerning travel aids. The file can also contain information about resources (e.g., further books to read, etc.)

Of course the previous example is just one example, and audio files can be generated and customized in an almost infinite number of ways. Any segments can be combined in any order.

An example of the system will now be presented. A user named “Joe” books a trip to Toronto, Canada using tripocity.com, an online travel agent. Tripocity.com is also affiliated with a credit card called ChargeitCard. The online travel agent also automatically transmits over the Internet Joe's travel data, which can include his name, address, trip destination, airline, travel dates, and ChargeitCard spending level (since ChargitCard is affiliated with tripocity, this information is accessible) to a customized audio generator. The customized audio generator contains two templates for a trip to Toronto, template A for a Chargeitcard gold level spender (a high spender) and template B for all other levels of Chargeitcard spenders (average to low). Jim's level is gold, so template A is selected. Template A points to the audio file, “You will enjoy your trip to Toronto immensely. Feel free to use your ChargeitCard anywhere you'd like.” Template A then contains data to retrieve the highest bidding fine restaurant in Toronto, which results in the “Torontula Restaurant,” which is associated with an audio file, “you may enjoy dining at the Torontula restaurant.” The last audio file Template A points to says, “Enjoy your trip!” These files are now all combined to create a single mp3 file: “You will enjoy your trip to Toronto immensely. Feel free to use your ChargeitCard anywhere you'd like. You may enjoy dining at the Torontula Restaurant. Enjoy your trip!” This mp3 file is now served to Jim. As an enhancement, Jim's name can be inserted into any of the segments as well, e.g., “Jim, you will enjoy your trip to Toronto immensely.” This can be done by storing audio files of all common names and retrieving the appropriate filing using the user's name.

The same example can now be applied to a different user, Jane, with the same trip information but Jane is not a gold level spender. Thus, template B is selected (a table can be used to determine which template to select based on trip (or other) data). Template B is similar to Template A, but instead of the fine restaurants it will include fast food restaurants. The highest bidding fast food restaurant is Jenny's Burgers. Thus, the audio file that will be generated for Jane will say, “You will enjoy your trip to Toronto immensely. Feel free to use your ChargeitCard anywhere you'd like. Jenny's burgers serves up great steaks on Main Street. Enjoy your trip!”

Note that advertisers bidders can place a maximum bid (this can be done for example as currently done on search engines such as Google). For example, if Jenny's burgers placed a maximum bid of $1.25, and the next highest bidder was $1.20 (Maggies burgers, also a fast food restaurant in Toronto), then Jenny's burgers wins and gets included into the audio file, upon which Jenny's account is charged the $1.25 (the money can be prepaid and deducted as needed, resolved monthly, or any other way known in the art). Once potential commercial establishments have been identified by certain criteria (in this example, being in Toronto and being a fast food restaurant), the winning establishment(s) can then be selected based on the winning bid. Other criteria may also optionally weigh into the selection factor, such as distance to traveler's hotel, etc. Also, an auction may be optional, and some commercial establishments may be included for free or because they paid a flat amount.

It is noted that any of the operations described herein can be performed in any order. The organization of the system presented here is merely one example, and can be accomplished in numerous other ways as well. Each block illustrated in any of the figures herein can communicate with any other block, in any other figure, even if such connection is not explicitly shown in the drawings or described herein. Each block/component can also perform any operation described herein. All of the methods described herein can be implemented on software running on a digital computer. Programs for such methods can be stored on a computer readable storage medium, such as a CD-ROM, DVD, etc.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method to generate a contextually specific custom audio file, the method comprising:
receiving user data which comprises travel data, relating to a user and the user's trip;
retrieving particular audio files relating to the user data;
combining the particular audio files to create a customized audio file; and
serving the customized audio file to the user.

2. The method as recited in claim 1, wherein the user data is obtained from an online travel agency.

3. The method as recited in claim 1, wherein the retrieving comprises:
querying a database for points of interest that meet criteria;
receiving bids from the points of interest; and
determining the particular audio files by taking the points of interest that meet the criteria and have the winning bids.

4. The method as recited in claim 1, further comprising:
determining a user template based on the user data,
wherein the particular audio files are identified in the user template.

5. The method as recited in claim 4, wherein the user template comprises a subtemplate comprising further audio files.

6. The method as recited in claim 1, wherein one of the particular audio files mentions a particular event occurring at or near the location the user will be visiting and occurring while the user will be at or near the location.

7. The method as recited in claim 1, wherein the customized audio file comprises a translation of a common phrase in a language used in a destination country of the trip.

8. The method as recited in claim 7, wherein the translation includes a selected point of interest.

9. The method as recited in claim 8, wherein the selected point of interest is selected by determining a highest bidder out of a subset of points of interest that meet criteria.

10. The method as recited in claim 1, wherein at least one of the audio files contains an advertisement for a commercial establishment in a same city the user is visiting in the trip.

11. The method as recited in claim 10, wherein the commercial establishment pays for inclusion in the audio file.

12. The method as recited in claim 11, wherein the commercial establishment pays additionally for each audio file the commercial establishment is advertised in.

13. The method as recited in claim 12, wherein the commercial establishment wins an auction involving other commercial establishments in order to be included in the audio file and pays an amount of a winning bid.

14. The method as recited in claim 1, wherein a first audio file out of the audio files comprises a generic segment without regard to specific information relating to the user and/or the trip, and a second file out of the audio files comprises a customized segment based on information relating to the user and/or the trip.

15. The method as recited in claim 1, further comprising:
storing template A and template B, each of template A and template B containing a list of audio files; and
picking a selected template from either template A or template B using the travel data,
wherein the retrieving used the selected template to retrieve the particular audio files which are used in the combining to create the customized audio file.

16. A computer readable storage medium storing a method to generate a contextually specific custom audio file, the method comprising:
receiving user data which comprises travel data, relating to a user and the user's trip;
retrieving particular audio files relating to the user data;
combining the particular audio files to create a customized audio file; and
serving the customized audio file to the user.

17. An apparatus to generate a contextually specific custom audio file, the apparatus comprising:
a receiving unit receiving user data which comprises travel data, relating to a user and the user's trip;
a retrieving unit retrieving particular audio files relating to the user data;
a combining unit combining the particular audio files to create a customized audio file; and
a serving unit serving the customized audio file to the user.
